(19) United States
(12) Patent Application Publication
(10) Pub. No.: US 2014/0083984 A1
(43) Pub. Date: Mar. 27, 2014

(54) Formation Of Laser Induced Periodic Surface Structures (LIPSS) With Picosecond Pulses

(71) Applicant: Timothy Gerke, Portland, OR (US)

(72) Inventor: Timothy Gerke, Portland, OR (US)

(21) Appl. No.: 14/033,620

(22) Filed: Sep. 23, 2013

Related U.S. Application Data
(60) Provisional application No. 61/704,555, filed on Sep. 23, 2012.
(60) Provisional application No. 61/704,512, filed on Sep. 23, 2012.

(51) Int. Cl. B23K 26/00; B23K 26/06

(52) U.S. Cl. CPC B23K 26/0084; B23K 26/0635
USPC 219/121.61; 219/121.85

(57) ABSTRACT

A method of forming a laser induced periodic surface structure (LIPSS), comprises directing a beam of picosecond laser pulses across the surface of a polycrystalline material to pattern the material with a LIPSS, where the laser pulses have a time duration of no greater than a selected pulse duration T and a pulse fluence above a threshold value of about H; wherein the laser pulses are directed across the surface so as to expose the polycrystalline material to at least a selected dosage; wherein T is 40 ps and the selected dosage is 20 J/mm²; and wherein H is in J/cm² and is given by H=[0.0284×ln (T)]+0.0195. Also disclosed are methods for forming a LIPSS on a semiconductor, for solid colorization of materials, and for forming cone-like features and/or regions of grating-like features where the grating-like features are oriented in substantially different directions.

### CROSS REFERENCE TO RELATED APPLICATIONS

The present application claims priority under 35 U.S.C. §119(e) to U.S. Provisional Patent Application Ser. No. 61/704,555, entitled “Materials Processing with Picosecond Pulses”, filed 23 Sep. 2012, and to U.S. Provisional Patent Application No. 61/704,512, also entitled “Materials Processing with Picosecond Pulses”, and also filed 23 Sep. 2012. The foregoing applications are incorporated by reference herein.

### FIELD OF THE INVENTION

The present invention relates to materials processing of materials with picosecond pulses, or more particularly in certain practices, to the formation of structures such as laser induced periodic surface structures (LIPSS) on substrates, or the colorization of substrates, with picosecond pulses.

### BACKGROUND

Pulsed lasers are becoming a preferred tool for laser micromachining applications. The extremely short pulse durations provide an avenue to athermal defect-free machining and open up applications, such as those involving nonlinear absorption, that require extremely high peak power densities. Ultrashort pulses have been found useful in applications including wafer dicing [1]-[3], glass and other transparent material machining [4] for consumer electronics, black silicon [5]-[6], waveguide writing [4], and ophthalmic surgery [7]-[9], as well as in other niche applications involving materials that are difficult to mark, modify, or machine. Many of these types of applications have conventionally been implemented and studied using femtosecond lasers.

Laser-induced periodic surface-structures (LIPSS) are another area of specific application [10]-[17]. LIPSS comprise surface relief, highly periodic (but imperfect) grating-like ripples and are usually built up by many laser pulses, typically 100s or 1000s of pulses per spot. Many LIPSS experimental studies have been conducted using a variety of laser sources and substrate materials. Numerous physical mechanisms have been proposed to explain the phenomenon of LIPSS—from differential heating in surface layers [10] to the more commonly accepted explanation involving excitation of surface plasmon polariton standing waves [12]-[14]—but so far there has not been overwhelming experimental evidence on any theory.

Regardless of the mechanism, LIPSS have been demonstrated on semiconductors [10]-[12], metals [13]-[15], glass [16], and even polymers [17]. However, such work has been done almost exclusively with femtosecond lasers. Femtosecond lasers do have many advantages, such as a shorter pulse length, which reduces the tendency to detrimentally heat the material being processed, as well as higher peak power, which can be necessary to initial many processes beneficial to altering a material with the laser pulses.

### SUMMARY

Applicants have discovered that picosecond sources, particularly under selected process windows, can be used to fabricate various types of LIPSS as well as to selectively colorize substrates. Femtosecond lasers do have the advantages noted above, but can also be one or more of more complicated, more expensive, larger or more difficult to use than longer pulse lasers.

In one aspect, there is disclosed a method of forming a laser induced periodic surface structure (LIPSS), comprising:

directing a beam of picosecond laser pulses across the surface of a polycrystalline material to pattern the material with a LIPSS, the laser pulses having a time duration of no greater than a selected pulse duration T and a pulse fluence above a threshold value of about H, and wherein the laser pulses are directed across the surface so as to expose the material to at least a selected dosage;

wherein T is 40 ps;

wherein the selected dosage is 20 J/mm²; and

wherein H is in J/cm² and is given by H=[0.0284×ln (T)]+0.0195.

The material can comprise a polycrystalline material, such as a metal. The metal can comprise, for example, steel or stainless steel.

In various practices of the method, T can be 35 ps, 30 ps, 25 ps, 20 ps, 15 ps, 10 ps, 5 ps or 3 ps.

In various practices of the method, the selected dosage can be 30 J/mm², 40 J/mm², 50 J/mm², or 60 J/mm². The method can be practiced with an upper limit to any of the foregoing selected dosages. For example, the dosage can be at least any of the foregoing selected dosages but not greater than, in various practices of the invention, 200 J/mm², 300 J/mm² or 450 J/mm².

The surface structure formed on the material can be substantially homogeneous (such as in shown in FIG. 8A and FIG. 9A). The surface structure can include grating like features (“lines”) wherein substantially all of the grating like features are substantially similarly oriented (for example, as in FIG. 8A and FIG. 9A). The grating like features can be characterized by an average periodicity.

In various practices of the method the laser pulses can comprise a wavelength selected from the range from 500 nm to 1080 nm, such a wavelength in the range of 520 to 550 nm or in the range 990 nm to 1070 nm. In particular pulses comprising a wavelength of about 532 nm are considered effective. Pulses comprising a wavelength of about 1060 nm are also considered of use.

In various practices of the method the beam can have a spot size (FWHM) of between 5 and 50 μm, between 10 and 40 μm, or between 25 and 35 μm. A spot size of about 30 μm can be effective.

The pulses can comprise linearly polarized pulses.

Any combination of the foregoing practices is within the scope of the methods.

The invention can also include methods of patterning the surface of a material to form selected structures having certain features or properties, such as, for example, cone like features and/or regions of grating like features where the grating like features (“lines”) are oriented in substantially different directions. The properties can include enhanced absorption of certain wavelengths of radiation incident on patterned surface.

In one aspect, there is disclosed a method of laser patterning the surface of a material with cone like features and/or regions of grating like features where the grating like features are oriented in substantially different directions, comprising:

directing a beam of picosecond laser pulses across the surface of a material to pattern the material, the laser pulses having a time duration not less than a selected pulse duration T and a pulse fluence above a threshold value of about H, and wherein the laser pulses are directed across the surface so as to expose the material to at least a selected dosage;

wherein T is 40 ps;

wherein the selected dosage is 50 J/mm²; and

wherein H is in J/cm² and is given by H=[0.0284×ln (T)]+0.0195.

The material can comprise a polycrystalline material, such as a metal (e.g., steel or stainless steel). The material can comprise a semiconductor material.

In various practices of the method, T can be 45 ps, 75 ps, 100 ps, 200 ps, 300 ps, 350 ps, 400 ps or 450 ps. In various practices of the method the picosecond pulses can comprise pulses having a pulse duration of no greater than, for example, 800 ps, 700 ps or 650 ps. The foregoing upper limits on pulse duration, in conjunction with any of the lower limits (e.g., not less than a selected pulse duration T) can provide for ranges having upper and lower bounds.

In various practices of the method, the selected dosage can be 70 J/mm², 100 J/mm², 150 J/mm², 200 J/mm² or 250 J/mm². The invention can be practiced with an upper limit to any of the foregoing selected dosages. For example, the dosage can be at least any of the foregoing selected dosages but not greater than, in various practices of the invention, than 200 J/mm², 300 J/mm² or 450 J/mm².

The surface pattern formed on the material can be inhomogeneous (for example, such as is shown in FIGS. 8B and 8C and the 46 ps and 415 ps results of FIG. 9. The patterning can include cone shape features and/or can provide for absorption of selected wavelengths incident on the patterned surface. The cone shape features can be on the scale of a few microns (e.g., between about 0.5 and about 10 microns in height and/or spaced apart at peaks by distances in the range of about 0.5 to about 10 microns. The patterning can include regions of grating-like features that are oriented in substantially different directions. See, for example, FIGS. 8B and 8C and the 46 ps and 415 ps results of FIG. 9. The regions of grating like features can be characterized by an average periodicity. The surface pattern can comprise a LIPSS.

Typically the grating like features are oriented substantially perpendicular to the polarization of the pulses (which are typically linearly polarized). Some of the regions of the grating like features can be oriented other than substantially perpendicular to the direction of the linear polarization of the incident pulses.

In various practices of the method the laser pulses can comprise a wavelength selected from the range from 500 nm to 1080 nm, such a wavelength in the range of 520 to 550 nm or in the range 990 nm to 1070 nm. In particular a wavelength of about 532 nm is considered effective.

In various practices of the method the beam can have a spot size (FWHM) of between 5 and 50 μm, between 10 and 40 μm, or between 25 and 35 μm. A spot size of about 30 μm can be effective.

Any combination of the foregoing practices is within the scope of the methods.

Also disclosed herein are methods pertaining to the solid colorization of a material. Solid colorization comprises colorization that is visible under normal, diffuse lighting, and where when the light is incident from a particular direction the color observed is not highly sensitive to the angle of illumination, such as in the case of a diffraction grating.

In another aspect of the invention, there is provided a method solidly colorizing a material, comprising:

directing a beam of picosecond laser pulses across the surface of the material to solidly colorize the material with a selected color, the pulses having a time duration of no less than a selected pulse duration T and wherein the laser pulses are directed across the surfaced so as to expose the material to at least a selected dosage;

wherein T is 80 ps; and

wherein the selected dosage is 100 J/mm².

The picosecond pulses can comprise pulses having a pulse fluence above a threshold value of about 0.5 J/cm².

The material can comprise a polycrystalline material. The polycrystalline material can comprise a metal, such as, for example, steel or stainless steel.

In various practices of the method, T can be 100 ps, 150 ps, 200 ps, 250 ps, 300 ps, 350 ps, or 400 ps. In various practices of the method the picosecond pulses can comprise pulses having a pulse duration of no greater than, for example, 800 ps, 700 ps or 650 ps. The foregoing upper limits on pulse duration, in conjunction with any of the lower limits (e.g., not less than a selected pulse duration T) can provide for ranges having upper and lower bounds.

In various practices of the method, the selected dosage can be 200 J/mm², 300 J/mm², 400 J/mm², or 500 J/mm². The invention can be practiced with an upper limit to any of the foregoing selected dosages. For example, the dosage can be at least any of the foregoing selected dosages but not greater than, in various practices of the invention, 3000 J/mm², 4000 J/mm² or 5000 J/mm².

In various practices of the method the laser pulses can comprise a wavelength selected from the range from 500 nm to 1080 nm, such a wavelength in the range of 520 to 550 nm or in the range 990 nm to 1070 nm. In particular pulses comprising a wavelength of about 532 nm are considered effective. Pulses comprising a wavelength of about 1060 nm are also considered of use.

The beam can have a spot size (FWHM) of between 5 and 50 μm, between 10 and 40 μm, or between 25 and 35 μm. A spot size of about 30 μm can be effective.

In various practices of the method, the selected color can comprise gold, silver, purple, blue, copper or grey.

In various practices of the method the material can comprise a semiconductor material (e.g. silicon) or a polycrystalline material, such as a metal (e.g., steel or stainless steel).

The pulses can comprise linearly polarized pulses.

Any combination of the foregoing practices is within the scope of the methods.

In another aspect, disclosed is a method of forming a laser induced periodic surface structure (LIPSS) on a semiconductor, comprising directing a beam of laser pulses across the surface of the semiconductor to pattern the semiconductor with a LIPSS, the laser pulses having a picosecond time duration, wherein the laser pulses are directed across the surface so as to expose the semiconductor to a dosage of at least 2.5 J/mm², and wherein the LIPSS is formed so as to be substantially homogeneous and to include grating like features wherein substantially all of the grating like features are substantially similarly oriented.

The semiconductor can comprise silicon. The laser pulses can include pulses having a fluence of at least about 0.08 J/cm2

In various practices of the method the laser pulses can comprise a wavelength selected from the range from 500 nm to 1080 nm, such a wavelength in the range of 520 to 550 nm or in the range 990 nm to 1070 nm. In particular pulses comprising a wavelength of about 532 nm are considered effective. Pulses comprising a wavelength of about 1060 nm are also considered of use.

In various practices of the method the beam can have a spot size (FWHM) of between 5 and 50 μm, between 10 and 40 μm, or between 25 and 35 μm. A spot size of about 30 μm can be effective.

The pulses can comprise linearly polarized pulses.

“Picosecond”, as used herein, means pulses having a time duration (full width half maximum or “FWHM”) ranging from 950 fs to 950 ps.

The foregoing features of this Summary can be combined with any of the other features in any of the aspects, practices or embodiments of the disclosure described herein, except where clearly mutually exclusive or a statement is explicitly made herein that such a combination is unworkable. To avoid undue repetition and length of the disclosure, every possible combination is not explicitly recited. As the skilled worker can ascertain, the methods of the present disclosure can include any of the features, or steps relating to the function or operation thereof, disclosed in conjunction with the description herein of apparatus and systems.

### BRIEF DESCRIPTION OF THE DRAWINGS

FIG. 1 schematically illustrates a picosecond laser micromachining system;

FIG. 2 is a diagram schematically illustrating dosage variation across a substrate due to variation of scan speed along the vertical axis and fluence across the horizontal axis (darker areas have higher dosage);

FIG. 3A-3C are reproductions of photographs of a LIPPS sample array held at three different angles of steepness to show different colors at the different angles;

FIGS. 4A-4C are reproductions of photographs of a LIPSS sample where the polarization of the laser beam used to form the LIPSS is varied from one consecutive square to the next and where for each of the FIGS. 4A-4C the LIPPS sample is held at a different angle of rotation in a plane;

FIG. 5 is a plot of the LIPSS pulse fluence threshold as a function of pulse duration;

FIG. 6 is a plot of LIPSS pulse fluence threshold of FIG. 5, plotted logarithmically as a function of pulse duration;

FIGS. 7A-7C are reproductions of macroscopic photographs of LIPSS samples fabricated with pulse durations of, respectively, 3 ps, 46 ps and 415 ps;

FIG. 8A-8C are microscopic photographs of the LIPSS samples of FIGS. 7A-7C, fabricated with pulse durations of, respectively, 3 ps, 46 ps and 415 ps;

FIGS. 9A-9C are reproductions of SEM images of LIPSS samples on stainless steel and made with pulses having pulse durations of, respectively, 3 ps, 46 ps and 415 ps;

FIGS. 10A-10B are reproductions of SEM images of a LIPSS sample fabricated with a pulse duration of 415 ps, with FIG. 10B being a higher magnification of the inset box shown in FIG. 10A;

FIG. 11A is a reproduction of a photograph of squares fabricated on a polished silicon substrate with 46 ps pulses, viewed under specific angular lighting to demonstrate the squares with LIPSS;

FIG. 11B is a reproduction of a photograph of the substrate of FIG. 11A viewed under normal room light.

FIG. 12A is a reproduction of a photograph of a sample made with pulses having a pulse duration of 415 ps and showing squares of solid colorization when viewed under normal room illumination;

FIG. 12B is a reproduction of a photograph of the sample of FIG. 12A viewed with under a specific angular lighting to demonstrate the squares with LIPPS versus those having solid colorization; and

FIG. 13 is a reproduction of a macroscopic photograph of an arbitrary shape (a logo) fabricated with pulses have a pulse duration of 3 ps.

Not every component is labeled in every one of the foregoing FIGURES, nor is every component of each embodiment of the invention shown where illustration is not considered necessary to allow those of ordinary skill in the art to understand the invention. The FIGURES are schematic and not necessarily to scale.

When considered in conjunction with the foregoing FIGURES, further features of the invention will become apparent from the following detailed description of non-limiting embodiments of the invention.

### DETAILED DESCRIPTION

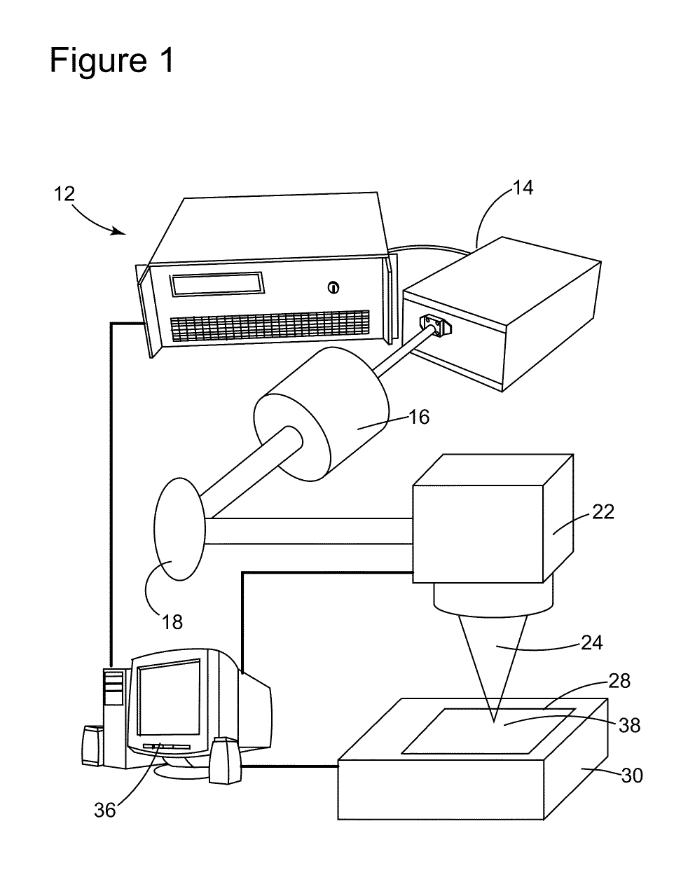

FIG. 1 schematically illustrates a picosecond laser micromachining system 12. The micromachining system 12 includes a picosecond fiber laser 14, a variable beam expander 16 to control the spot size at the work surface, and a mirror or set of mirrors 18 to redirect the beam to a 2D galvo-scanner 22 from ScanLabs (HurryScan II-14). The 2D galvo-scanner 22 can move the laser beam 24 relative to the workpiece 28. A 2D translation stage 30 supports the workpiece 28 and can position the workpiece 28 vertically at the beam focus (as well as in the x direction in the embodiment shown in FIG. 1). (As will be appreciated by one or ordinary skill in the art, relative movement between the beam 24 and the workpiece 28 could be effected by a 3D translation stage, which would allow translation along the x, y and z axes). A computer 34 controls the scanner system 22 and synchronously controls the output of the picosecond fiber laser 14 to enable arbitrary patterning of the workpiece 28. The scanner 22 objective can comprise a 100 mm focal length telecentric objective lens with an input aperture limited by the scanner 22 at about 14 mm. This combination, along with the variable beam expander 16 to set input laser beam size, provides the capability of a range of focused spot sizes at the work surface 38 of the workpiece 28 from under 10 μm to over 60 μm. Typically the spot size was fixed at 30 μm.

The picosecond fibre laser 14 can comprise a Fianium model HE1060/532 providing 5 μJ pulses at a wavelength of 532 nm with selectable pulsewidths of 46, 110, 220, and 415 ps at up to 500 kHz, or another Fianium laser with continuously tunable pulsewidth of 3-10 ps with up to 3 μJ pulse energy (532 nm) at up to 500 kHz. The Fianium fibre lasers use a fiber MOPA (master oscillator power amplifier) technology that allows for a varying repetition rate and pulse energy without affecting other parameters such as beam quality, pulse width, and linewidth, which is a common problem for Q-switched DPSS systems.

The picosecond fibre laser system 12 of FIGURE was used to fabricate LIPSS in squares on sample workpieces. The squares were fabricated by scanning the beam spot in a raster-style pattern with a line-to-line spacing of 5 μm. Laser parameters varied included pulse energy (fluence) and linear scanning speed, each of which contributes to the total deposited energy dose. Faster scan speed results in fewer total pulses per unit area and thus a lower total dose, while higher pulse energy increases the total applied dose.

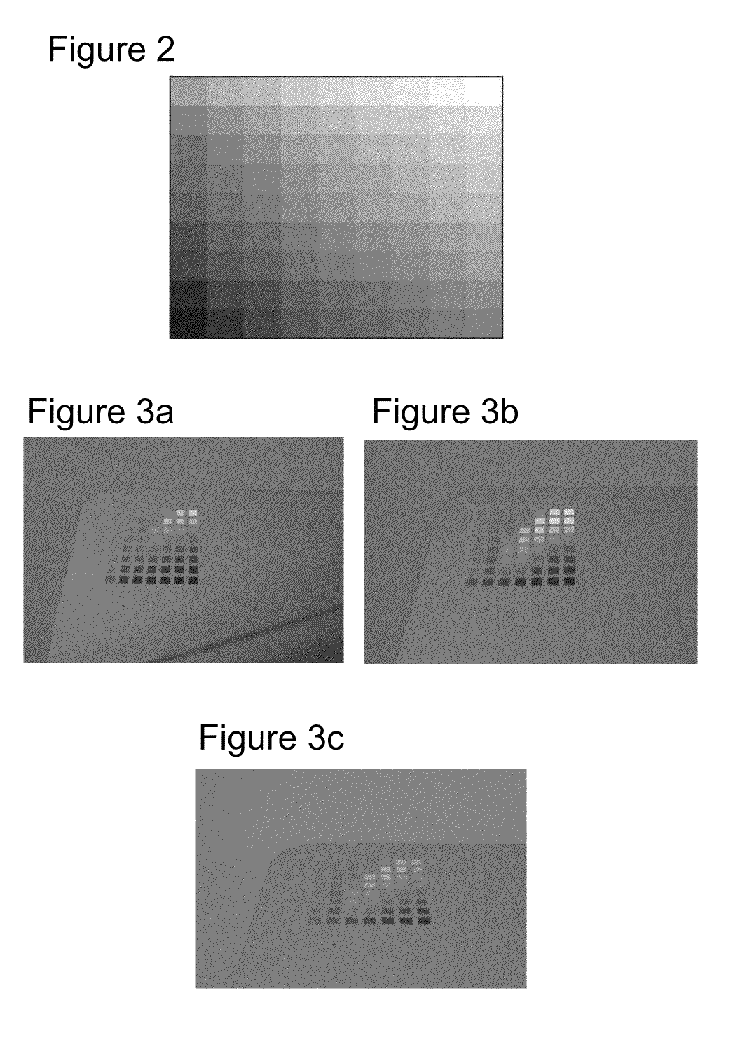

FIG. 2 is a diagram schematically illustrating dosage variation across a substrate due to variation of increase in scan speed with increasing distance along the horizontal axis and increase of fluence with increasing distance along the vertical axis. As can be seen, many square samples were fabricated in an array. Higher total laser doses are represented by the darker squares. The highest and lowest doses are located at two corners of the array, while the diagonal between the other two corners is comprised of squares of approximately equal total dose. Linear scan speeds investigated were 50-3000 mm/s, and the applied fluence values ranged from 0.02-0.5 J/cm².

FIG. 3A-3C are reproductions of photographs of a LIPPS sample array fabricated on stainless steel and held at three different lighting conditions of increasing angle from top left (FIG. 3A) to top right (FIG. 3B) to bottom (FIG. 3C). This sample array was fabricated with 3 ps pulses at 532 nm. The increasing angle causes the samples that resulted in LIPSS (generally, the shiny squares) to reflect the blue (FIG. 3A), green (FIG. 3B), and red (FIG. 3C) portions of the spectrum, respectively, as would be expected from a diffraction grating of fixed period or line density.

FIGS. 3A-3C also elucidate the process parameters most effective in fabricating high quality LIPSS. For this sample array, linear scan speed increases from bottom to top along the vertical axis, and fluence increases from left to right along the horizontal axis, so the iso-dosage line is from bottom left to top right. The top left represents the lowest dose and the bottom right represents the highest dose. Not surprisingly, the lowest dose results in less material modification, and no LIPSS effects, while the highest dose results in a dark, matte-textured mark. A relatively wide range of parameters produced high-quality LIPSS effects. This can be seen in FIGS. 3A-3C where the large number of the squares in the top right reflect brightly. The highest quality LIPSS (defined by brightest color reflection) occur for the highest scan speeds of 1000-3000 mm/s, and the highest fluence. At 3000 mm/s, the total throughput is more than 10 mm²/s, and the pulse-to-pulse overlap is so small that only around 10 pulses are applied to any point on the substrate.

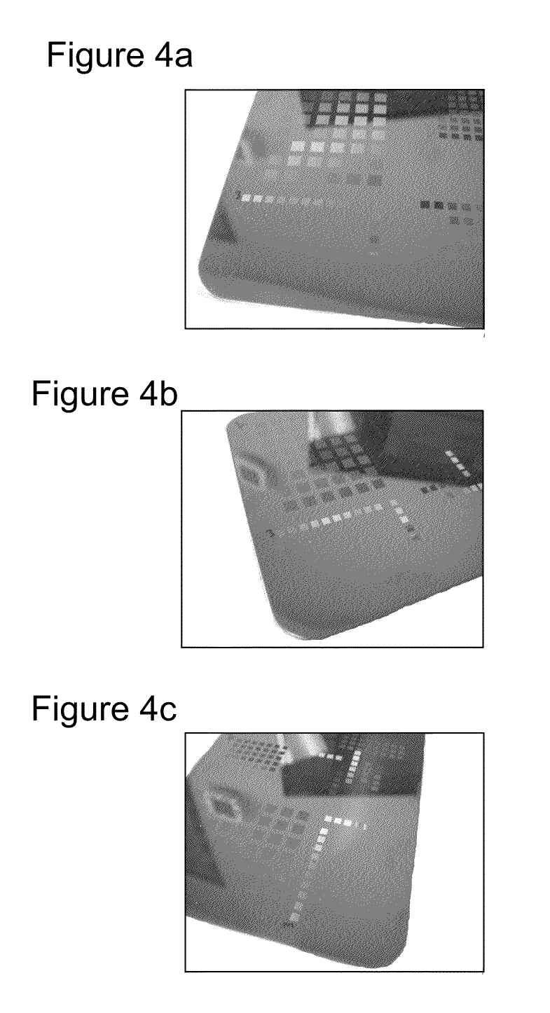

FIGS. 4A-4C are reproductions of a photographs of a LIPSS sample where the polarization of the laser beam use to form the LIPSS is varied. A line of squares was fabricated while rotating the applied polarization by 10 degrees from one consecutive square to the next. The laser polarization defined the LIPSS axis, as expected. Note that high-brightness wavelength-dependant reflection of illumination for the appropriate squares, which shifted from one end of the linear array to the other as the sample was rotated in a plane through a full 90 degrees (see the line of squares centered in each photograph).

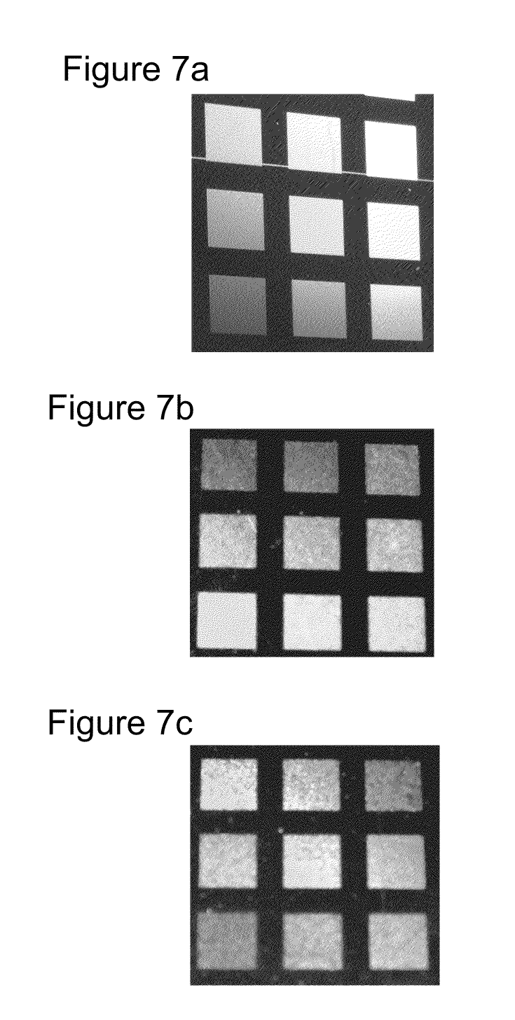

In addition to the 3 ps samples discussed above, sample arrays were fabricated with 46 and 415 ps pulses (see FIGS. 7A-7C, discussed below). A range of laser process parameters resulted in high quality LIPSS samples. (FIGS. 3A-3C illustrate this range as a cloud of square samples crowded around the top right corner of the array where good reflection occurs). The range of laser parameters was, however, dependent upon the laser pulsewidth. For all samples it appeared that beyond a certain threshold in fluence the LIPSS effects were maintainable by increasing the scan rate along with fluence, effectively maintaining a uniform total dose. The pulse fluence to initiate a good LIPSS surface varied with pulsewidth, however. At 3 ps, the required pulse fluence was only about 0.05 J/cm², while at 46 ps it required about 0.13 J/cm², and for 415 ps, about 0.19 J/cm² was required.

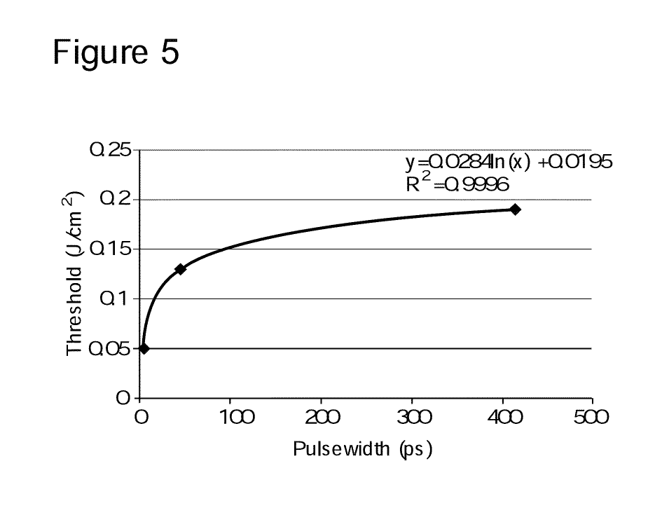

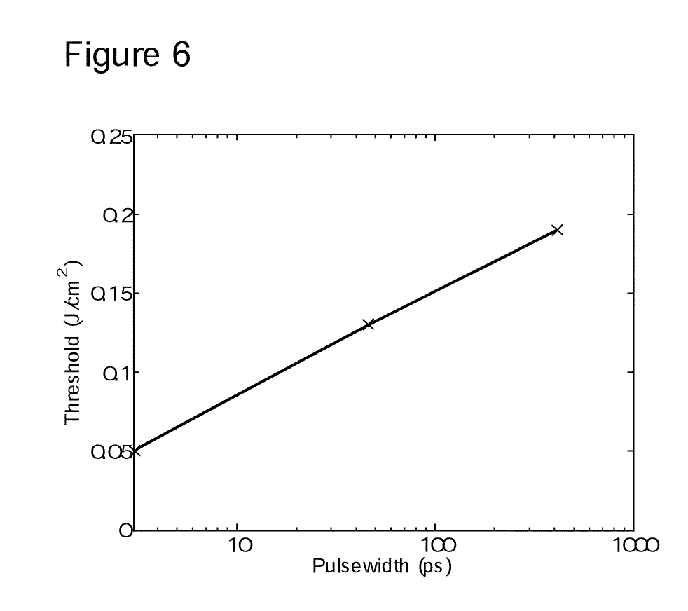

FIG. 5 is a plot of LIPSS pulse fluence threshold as a function of pulse duration. The points are fit to the formula for threshold of fluence threshold=[0.0284×ln (T)]+0.0195, where T=pulse duration and ln is the natural log. This relationship allows, for example, a pulse fluence threshold for a 12 ps pulse to be determined to be about 0.09 J/cm². Other values can be similarly calculated. FIG. 6 is a plot of LIPSS pulse fluence threshold of FIG. 5 plotted logarithmically as a function of pulse duration. Good LIPSS effects were achieved for each of the pulsewidths from the pulse fluence threshold all the way up to the maximum fluence attempted, which was about 0.15 J/cm² at 3 ps, and about 0.4 J/cm² for 46 ps and 415 ps. As pulse fluence increases the best LIPSS occur at increasingly higher scan speeds.

FIGS. 7A-7C are reproductions of macroscopic photographs of the LIPSS samples fabricated with pulse durations of, respectively, 3 ps, 46 ps and 415 ps. The results were similar in that high quality LIPSS effects were observed at high speed and high fluence, while darker matte-textured marks resulted at low speeds. A large difference, however, in macroscopic and microscopic appearance was noticeable for the LIPSS samples. At both 46 and 415 ps the LIPSS squares appeared very grainy when observed by eye, and this effect is demonstrated in FIGS. 7B-7C, where FIG. 7A shows the 3 ps result, FIG. 7B shows the 46 ps result, and FIG. 7C shows 415 ps result. The 46 ps sample of FIG. 7B and 415 ps sample of FIG. 7C both have a grainy texture to them even for the best achievable results, with the 415 ps samples of FIG. 7C being slightly worse in this respect than the 46 ps samples shown in FIG. 7B. The 3 ps squares of FIG. 7A, on the other hand, are homogenously colored and do not demonstrate any of the grainy appearance.

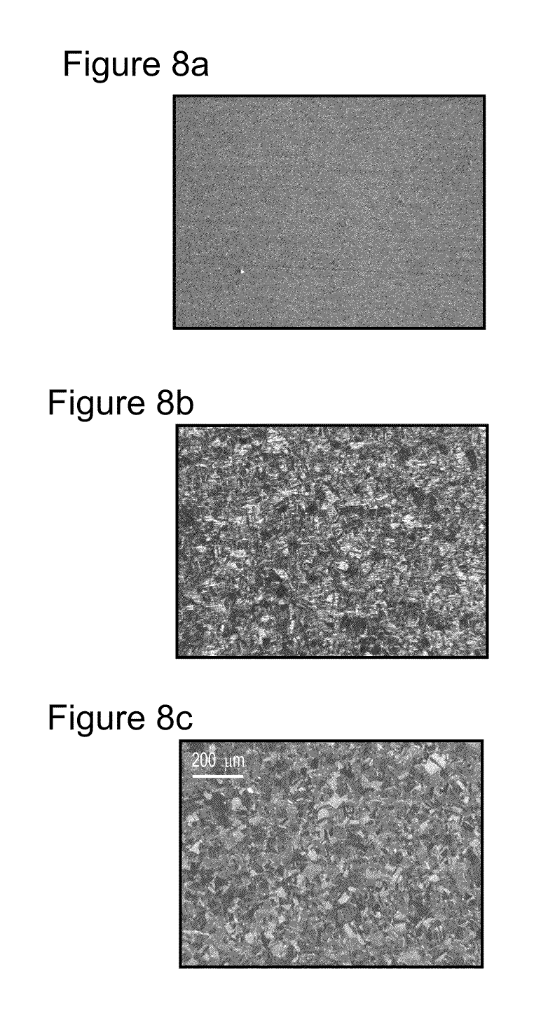

Upon closer inspection in an optical microscope, the surface non-uniformity is even more evident. FIG. 8A-8C are microscopic photographs of LIPSS samples of FIG. 7A-7C, fabricated with pulse durations of, respectively, 3 ps (FIG. 8A), 46 ps (FIG. 8B) and 415 ps (FIG. 8C). Here the individual grains can be seen for 46 (FIG. 8B) and 415 ps (FIG. 8C) results, where some are brightly colored while others appear to be quite dark. The grain structure appears to be on a size scale of approximately 10-30 μm. The 3 ps result (FIG. 8A) shows a very solid color with no grainy appearance, in agreement with the macroscopic evaluation.

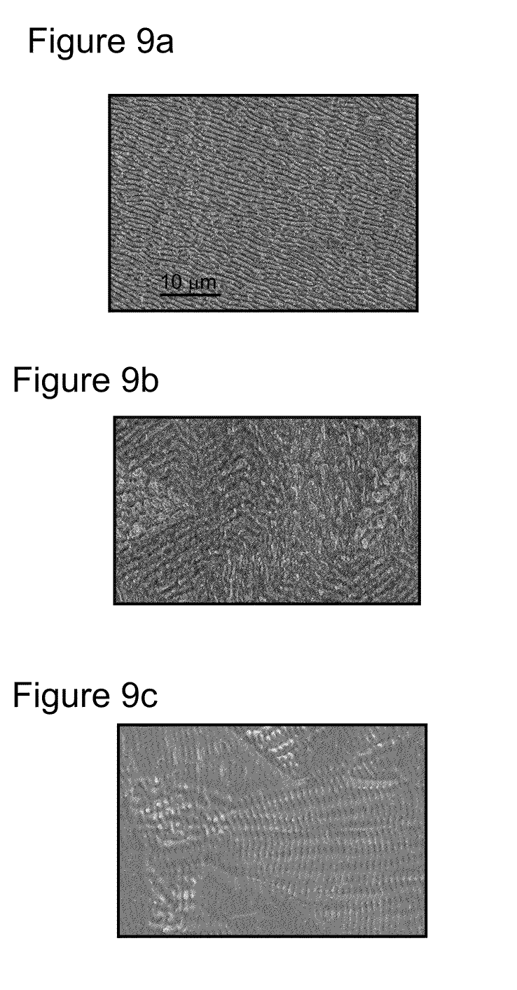

Samples fabricated using each pulsewidth were examined in a SEM to further evaluate the nature of the grainy appearance of the longer pulsewidth results. FIGS. 9A-9C are reproductions of SEM images of the LIPSS samples shown in FIGS. 7A-7C and FIGS. 8A-8C. The 3 ps sample (FIG. 9A) shows a very homogenous grating-like periodic surface structure as expected. The 46 ps sample (FIG. 9B) shows a similar behavior, although only in particular areas, while other areas demonstrate a different surface structure. The 415 ps sample (FIG. 9C) appears similar to the 46 ps with the exception that the LIPSS areas appear much smoother. In addition, some of the grating-like structures seen in both 46 ps and 415 ps are not oriented in the same direction but appear to align with a microscopic polycrystalline orientation or perpendicular to the edges. Conventionally, the orientation of LIPSS is understood to be established by the laser polarization, and this was verified with the 3 ps result. Grating lines orienting along different directions in a single sample and not determined by polarization is understood to be a new phenomenon.

The different orientations of the grating lines may be caused by a scattering of the surface plasmon wave being sufficiently influenced by the microcrystalline orientations and facet edges. The laser spot size was approximately the size of the images shown in FIGS. 9A-9C, so entire microcrystal structures were illuminated at once, which is likely why the microcrystals themselves have homogenous surface structures.

The periods of the grating lines shown in FIGS. 9A-9C were measured and significant differences found for the different pulsewidths. The periods were measured to be approximately 417 nm, 444 nm and 513 nm for 3 ps (FIG. 9A), 46 ps (FIG. 9B), and 415 ps (FIG. 9A), respectively. The variation in periodicity is also observable macroscopically by eye, where the angle between illumination and viewing is noticeably larger for the short pulsewidth than the long pulsewidth. There has been other experimental evidence along these lines where some experiments have shown the LIPSS period to be approximately that of the wavelength, while others have shown nearly λ/2 periodicity, and there is no obvious trend. To our knowledge there has not been a consensus on the theory behind LIPSS generation to fully explain these affects across all wavelength sources, pulsewidths, and materials.

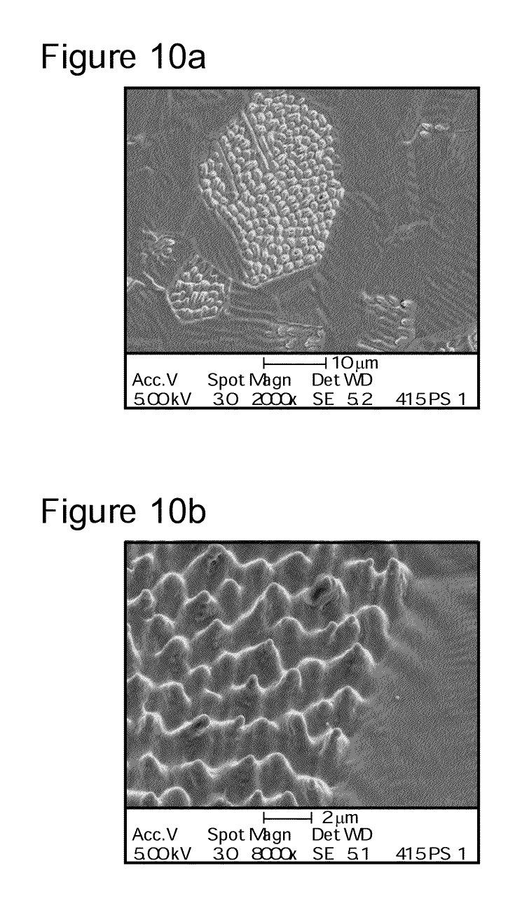

Some of the microcrystals' surface structures for the 46 and 415 ps samples contain not the typical grating-like structures of LIPSS, but finger-like bumps that protrude vertically from the surface similar to the structures observed with black silicon [5]. FIGS. 10A-10B are SEM images of a LIPSS sample fabricated with a pulse duration of 415 ps, with FIG. 10B being a higher magnification of the inset box shown in FIG. 10A. These surface effects are can be seen from the lower figure to have a size of about a few microns, which is also in agreement with black silicon feature sizes that result in enhanced visible spectrum absorption [6]

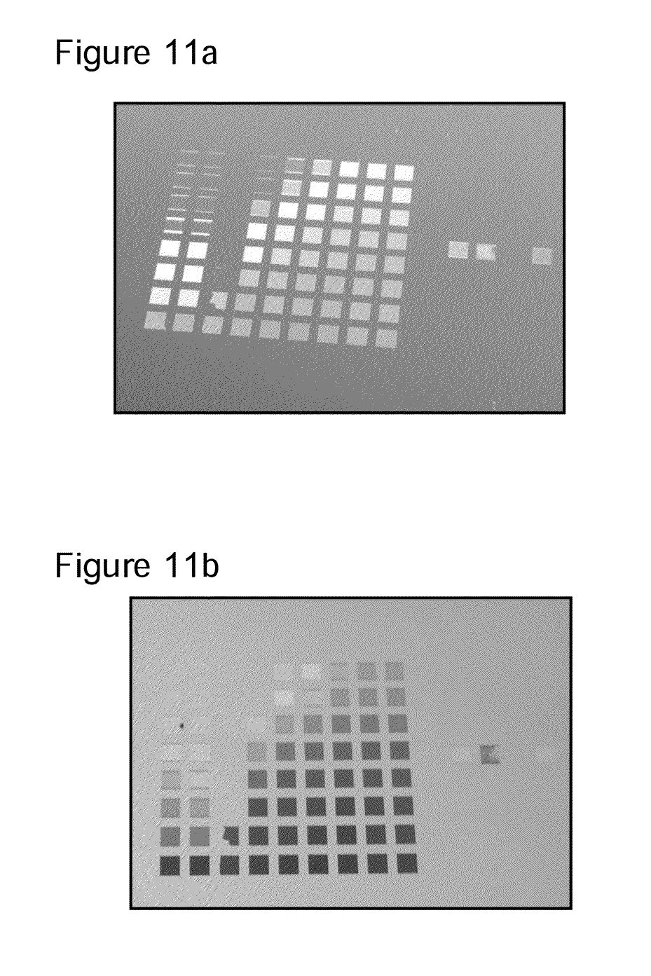

Although the work above involves stainless steel samples, the generation of LIPSS is not limited to stainless steel substrates, however. It has been reported in a number of metal and semiconductor substrates. Accordingly, LIPSS are demonstrated herein on polished, single-crystalline silicon substrates. FIGS. 11A-11B show a sample fabricated on a polished silicon substrate with 46 ps pulses. FIG. 11A shows the sample viewed under a specific angular lighting to demonstrate the squares with LIPSS, while FIG. 11B shows the LIPSS samples under normal room light. The results are very similar to those achieved on stainless steel with the exception of no grainy appearance, which we considered to be expected of a single crystalline substrate rather than the polycrystalline nature of the steel which appeared to drive the inhomogeneity of the results.

The laser parameters for forming LIPSS on silicon were very similar to that of steel. For the silicon substrate we found good LIPSS samples for laser fluences around 0.08 J/cm² and higher, and at linear scan rates of 500-1000 mm/s. Again, the higher the fluence, the higher the scan rate could be while still achieving good LIPSS.

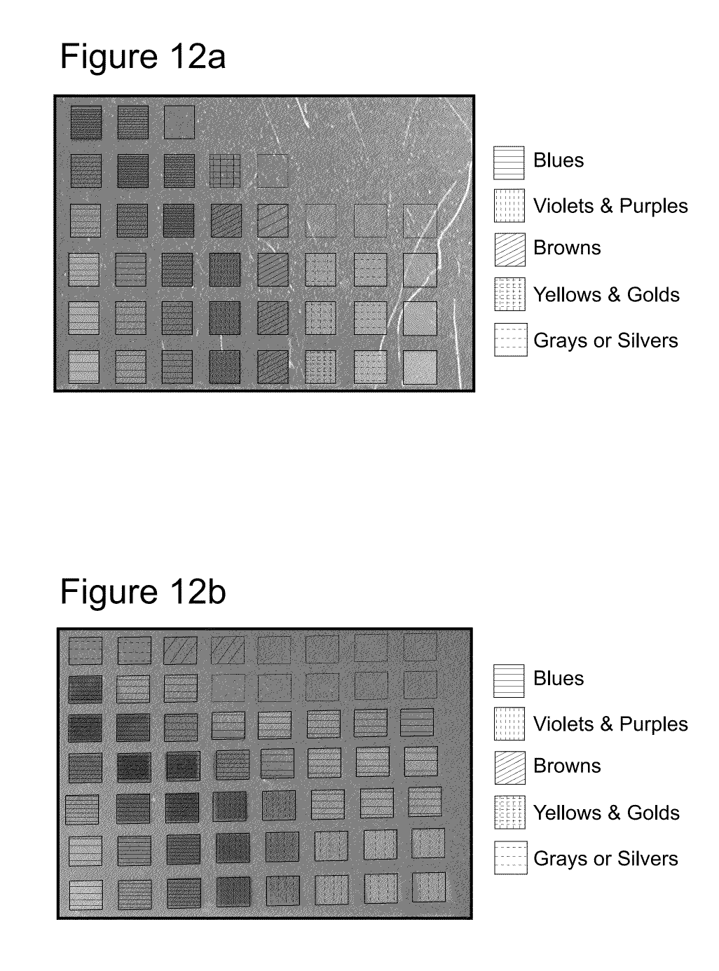

Solid colorization found to occur for a few higher dose stainless steel samples when using 415 ps pulses. Unlike the LIPSS effect, where bright colors are reflected under particular lighting conditions effectively identical to a diffraction grating, this solid colorization is not as brilliant, but is visible under normal diffuse room lighting. Solid colorization is a known effect of longer pulse lasers on metal surfaces and is created by a controlled oxidization of the surface of the metal substrate [18]. The oxidization parameters can be controlled by varying the applied dosage (changing fluence or scan speed), which results in a variety of achievable colors. We achieved colors such as gold, silver, purple, blue, copper, and grey. FIG. 12A is a reproduction of a photograph of a sample made with pulses having pulse duration of 415 ps and viewed under normal room illumination, and FIG. 12B is the sample of FIG. 12A viewed with under a specific angular lighting to demonstrate the squares with LIPPS versus those having solid colorization. The LIPSS squares are the blue squares in FIG. 12B that do not appear in FIG. 12A. The bottom row of samples in FIG. 12A best illustrates the solid colorization and is the row of maximum fluence with varying scan speed, with total dose decreasing from left to right. Solid colorization was not observed for any available laser parameters for the two shorter pulsewidths, which is likely because the shorter interaction time results in direct and immediate ablation rather than significant heating and melting. Fluence values for solid colorization were 0.5-0.8 J/cm² (0.8 was max available). Total dose ranged from 100-3000 J/mm², mostly above the doses for LIPSS.

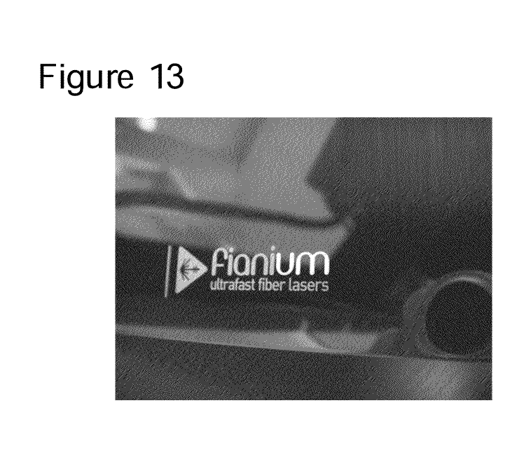

Because the scanner system and the laser output are both synchronously controlled, arbitrary 2D patterns can be fabricated. FIG. 13 is a reproduction of a macroscopic photograph of an arbitrary shape (a logo) fabricated on a stainless steel substrate with pulses having a pulse duration of 3 ps and a wavelength of 532 nm. The laser polarization was oriented horizontally. Horizontal polarization results in LIPSS oriented vertically (orthogonal to incident polarization), and thus effectively creates a grating-like structure that disperses wavelengths laterally, giving the logo a rainbow appearance.

Ultrafast laser microprocessing is a growing technology for a number of industrial applications, such as thin-film photovoltaics, the scribing of very hard materials, and niche marking applications. Picosecond pulses lasers are capable of athermal material modification, such as laser-induced periodic surface structures (LIPSS) and black silicon, which opens up interesting marking regimes that are not easily accessed by longer pulse sources. Shown herein are the ability to create LIPSS on metals and semiconductors such as stainless steel and single-crystalline and poly-crystalline silicon with ps pulses. Starkly different regimes of marks become possible with the ability to tune pulsewidth and pulse energy over a wide range. Solid colorization, darkening, and holographic colorization are experimentally demonstrated on an array of substrates. We note that the pulse fluence threshold increases as pulsewidth increases. The LIPSS orientation was confirmed to be dictated by the laser polarization, as expected and previously observed, but with the exception of the longer pulse sources providing non-homogenous affects over an entire sample. For the longer pulses, we observe the LIPSS orientation to be dictated by a polycrystalline geometry of the substrate. We verified applicability on semiconductors as well by repeating a sample on polished silicon and we expect many other substrate materials to work as well. We also showed an ability to create solid, lighting independent colorization using 415 ps pulses.

We focus mainly herein on stainless steel and silicon, but we do so with the understanding that the work could be applied to a vast array of substrates, including other metals. We show that on these materials, the pulsewidth of the laser causes significant differences in the LIPSS quality and period. We also demonstrate the ability to create high quality LIPSS features in arbitrary patterns over a range of laser parameters and at very high throughput rates.

Those of ordinary skill in the art will readily envision a variety of other means and structures for performing the functions and/or obtaining the results or advantages described herein and each of such variations or modifications is deemed to be within the scope of the present invention. More generally, those skilled in the art would readily appreciate that all parameters, dimensions, materials and configurations described herein are meant to be exemplary and that actual parameters, dimensions, materials and configurations will depend on specific applications for which the teachings of the present invention are used.

Those skilled in the art will recognize or be able to ascertain using no more than routine experimentation, many equivalents to the specific embodiments of the invention described herein. It is therefore to be understood that the foregoing embodiments are presented by way of example only and that within the scope of the appended claims, and equivalents thereto, the invention may be practiced otherwise than as specifically described.

In the claims as well as in the specification above all transitional phrases such as “comprising”, “including”, “carrying”, “having”, “containing”, “involving” and the like are understood to be open-ended. Only the transitional phrases “consisting of” and “consisting essentially of” shall be closed or semi-closed transitional phrases, respectively, as set forth in the U.S. Patent Office Manual of Patent Examining Procedure §2111.03, 8^{th} Edition, Revision 8. Furthermore, statements in the specification, such as, for example, definitions, are understood to be open ended unless otherwise explicitly limited.

The phrase “A or B” as in “one of A or B” is generally meant to express the inclusive “or” function, meaning that all three of the possibilities of A, B or both A and B are included, unless the context clearly indicates that the exclusive “or” is appropriate (i.e., A and B are mutually exclusive and cannot be present at the same time).

It is generally well accepted in patent law that “a” means “at least one” or “one or more.” Nevertheless, there are occasionally holdings to the contrary. For clarity, as used herein “a” and the like mean “at least one” or “one or more.” The phrase “at least one” may at times be explicitly used to emphasize this point. Use of the phrase “at least one” in one claim recitation is not to be taken to mean that the absence of such a term in another recitation (e.g., simply using “a”) is somehow more limiting. Furthermore, later reference to the term “at least one” as in “said at least one” should not be taken to introduce additional limitations absent express recitation of such limitations. For example, recitation that an apparatus includes “at least one widget” and subsequent recitation that “said at least one widget is colored red” does not mean that the claim requires all widgets of an apparatus that has more than one widget to be red. The claim shall read on an apparatus having one or more widgets provided simply that at least one of the widgets is colored red. Similarly, the recitation that “each of a plurality” of widgets is colored red shall also not mean that all widgets of an apparatus that has more than two red widgets must be red; plurality means two or more and the limitation reads on two or more widgets being red, regardless of whether a third is included that is not red, absent more limiting explicit language (e.g., a recitation to the effect that each and every widget of a plurality of widgets is red).

### REFERENCES

[1] Kim, T., Kim, H. S., Hetterich, M., Jones, D., Girkin, J. M., Bente, E., and Dawson, M. D. (2001) Femtosecond laser machining of gallium nitride, Mater. Sci. Eng. B 82, 262
[2] Gu, E., Jeon, C. W., Choi, H. W., Rice, G., Dawson, M. D., Illy, E. K. and Knowles, M. R. H. (2004) Micromachining and dicing of sapphire, gallium nitride and micro LED devices with UV copper vapour laser, Thin Solid Films 453-454, 462-466.
[3] Fukuyo, F., Fukumitsu, K., Uchiyama, N., and Wakuda, T. (2006) Laser processing method and laser processing apparatus, U.S. Pat. No. 6,992,026. U.S. Patent and Trademark Office.
[4] Gattass, R. R. and Mazur E. (2008) Femtosecond laser micromachining in transparent materials Nature Photonics, 2, 219-225.
[5] Her, T.-H., Finlay, R. J., Wu, C., Deliwala, S., and Mazur, E. (1998) Microstructuring of silicon with femtosecond laser pulses, Appl. Phys. Lett. 73, 1673-1675.
[6] Sarnet, T., Halbwax, M., Torres, R., Delaporte, P., Sentis, M., Martinuzzi, S., Vervisch, V., Torregrosa, F., Etienne, H., Roux, L., and Bastide, S., (2008) Femtosecond laser for black silicon and photovoltaic cells, in Proceedings of SPIE Commercial and Biomedical Applications of Ultrafast Lasers VIII 688, 688119.
[7] Stern, D., Schoenlein, R. W., Puliafito, C. A., Dobi, E. T., Birngruber, R., and Fujimoto, J. G. (1989) Corneal ablation by nanosecond, picosecond, and femtosecond lasers at 532 and 625 nm, Arch. Ophthalmol. 107, 587-592.
[8] Puliafito, C. A. and Steinert, R. F. (1984) Short-pulsed Nd:YAG laser microsurgery of the eye: Biophysical consideration, IEEE J. Quantum Electron., 20, 1442-1448.
[9] Juhasz, T., Loesel, F. H., Kurtz, R. M., Horvath, C., Bille, J. F., and Mourou, G. (1999) Corneal Refractive Surgery with Femtosecond Lasers, IEEE J. Sel. Top. Quant. 5, 902-910.
[10] Oron, M. and Sørensen, G. (1979) New experimental evidence of the periodic surface structure in laser annealing, Appl. Phys. Lett. 35, 782-784.
[11] Emmony, D. C., Howson, R. P., and Willis, L. J. (1973) Laser mirror damage in germanium at 10.6 μm, Appl. Phys. Lett. 23, 598.
[12] Fauchet, P. M. and Siegman, A. E. (1982) Surface ripples on silicon and gallium arsenide under picosecond laser illumination, Appl. Phys. A 40, 824-826.
[13] Vorobyev, A. Y. and Guo, C. (2008) Colorizing metals with femtosecond laser pulses, Appl. Phys. Lett. 92, 041914.
[14] Vorobyev, A. Y. and Makin, V. S., and Guo, C. (2007) Periodic ordering of random surface nanostructures induced by femtosecond laser pulses on metals, J. of Appl. Phys. 101, 034903.
[15] Dusser, B., Sagan, Z., Soder, H., Faurel, N., Colombier, J. P., Jourlin, M., and Audouard, E., (2009) Controlled nanostructures formation by ultrafast laser pulses for color marking, Opt. Express 18, 2913-2924.
[16] Borowiec, A. and Haugen, H. K. (2007) Subwavelength ripple formation on the surfaces of compound semiconductors irradiated with femtosecond laser pulses, Appl. Phys. Lett. 82, 4462-4464.
[17] Heitz, J., Arenholz, E., Bäuerle, D., Sauerbrey, R., and Phillips, H. M. (1994) Femtosecond excimer laser induced structure formation on polymers, Appl. Phys. A 59, 289-293.
[18] Pérez del Pino, A., Serra, P., and Morenza, J. L. (2002) Coloring of titanium by pulsed laser processing in air, Thin Solid Films 415, 201-205.

What is claimed is:

1. A method of forming a laser induced periodic surface structure (LIPSS), comprising:
directing a beam of picosecond laser pulses across the surface of a material to pattern the material with a LIPSS, the laser pulses having a time duration of no greater than a selected pulse duration T and a pulse fluence above a threshold value of about H, and wherein the laser pulses are directed across the surface so as to expose the material to at least a selected dosage;
wherein T is 40 ps;
wherein the selected dosage is 20 J/mm²; and
wherein H is in J/cm² and is given by H=[0.0284×ln (T)]+0.0195.

2. The method of claim 1 wherein the material comprises a polycrystalline material.

3. The method of claim 1 wherein T is 25 ps.

4. The method of claim 1 wherein T is 15 ps.

5. The method of claim 1 wherein the selected dosage is 40 J/mm².

6. The method of claim 1 wherein the selected dosage is 60 J/mm².

7. The method of claim 1 wherein the dosage is not greater than 300 J/mm².

8. The method of claim 1 wherein the LIPSS comprises grating like features wherein substantially all of the grating like features are substantially similarly oriented.

9. The method of claim 1 wherein the laser pulses comprise a wavelength selected from the range of 520 nm to 550 nm.

10. The method of claim 1 wherein the beam comprises a spot size of between 5 and 50 μm.

11. The method claim 1 wherein the pulses comprise linearly polarized pulses.

12. The method of claim 1 wherein the laser pulses comprise a wavelength selected from the range from 520 to 550 nm.

13. A method of laser patterning the surface of a material with cone like features and/or regions of grating like features where the grating like features are oriented in substantially different directions, comprising:
directing a beam of picosecond laser pulses across the surface of a material to pattern the material, the laser pulses having a time duration not less than a selected pulse duration T and a pulse fluence above a threshold value of about H, and wherein the laser pulses are directed across the surface so as to expose the material to at least a selected dosage;
wherein T is 40 ps;
wherein the selected dosage is 50 J/mm²; and
wherein H is in J/cm² and is given by H=[0.0284×ln (T)]+0.0195.

14. The method of claim 13 wherein the material comprises a polycrystalline material.

15. The method of claim 13 wherein T is 100 ps.

16. The method of claim 13 wherein T is 350 ps.

17. The method of claim 13 wherein the picosecond pulses have pulse duration of no greater than 800 ps.

18. The method of claim 13 wherein the selected dosage is 70 J/mm².

19. The method of claim 13 wherein the selected dosage is not greater than 200 J/mm².

20. The method of claim 13 where the laser patterning of the surface of the material patterns the material with cone shaped features.

21. The method of claim 13 where the laser patterning of the surface of the material patterns the material with regions of grating like features where the grating like features are oriented in substantially different directions.

22. The method of claim 13 wherein the laser pulses comprise a wavelength selected from the range from 520 to 550 nm.
